(19) United States
(12) Patent Application Publication
(10) Pub. No.: US 2022/0133114 A1
(43) Pub. Date: May 5, 2022

(54) Autonomous Cleaning Robot

(71) Applicants: Shiwei Liu, Lehi, UT (US); Lishao Wang, Halifax (CA); Xiaoge Cheng, Beijing (CN); Ran Zhang, Beijing (CN); Zibo Wang, Zhuhai (CN)

(72) Inventors: Shiwei Liu, Lehi, UT (US); Lishao Wang, Halifax (CA); Xiaoge Cheng, Beijing (CN); Ran Zhang, Beijing (CN); Zibo Wang, Zhuhai (CN)

(21) Appl. No.: 17/516,888

(22) Filed: Nov. 2, 2021

Related U.S. Application Data
(60) Provisional application No. 63/108,458, filed on Nov. 2, 2020.

(51) Int. Cl. A47L 11/40; G05D 1/02; G06N 20/00

(52) U.S. Cl. CPC A47L 11/4011; G05D 1/0219; G05D 1/0221; G05D 1/0238; G05D 2201/0203; G05D 1/0287; G06N 20/00; A47L 2201/04; A47L 2201/06; G05D 1/0246

(57) ABSTRACT

The present invention, in some embodiments thereof, relates to an autonomous cleaning robot adapted to clean and/or disinfect an object or environment comprising of a navigation means to navigate an environment of operation to perform a cleaning and/or disinfection task, a target acquisition means making the cleaning robot is capable of detecting obstacles in its environment or objects or an environment for cleaning and/or disinfection, and a disinfection means to clean and/or disinfect detected object or an environment, the disinfection means being electrostatically operated, whereby a disinfectant in the disinfection means is charged by an electrostatic charge to increase adherence to an object or an environment to reduce the amount of disinfectant used. According to some embodiments, the navigation is autonomous, non-human operated. According to another embodiments, the robot may be coupled to a swarm intelligence via a high speed data link provided therefor.

### FIELD OF INVENTION

In general, the current invention relates to relates to an autonomous cleaning robot adapted to clean and/or disinfect an object or environment. More specifically, to a cleaning robot comprising of a navigation means to navigate an environment of operation to perform a cleaning and/or disinfection task, a target acquisition means making the cleaning robot is capable of detecting obstacles in its environment or objects or an environment for cleaning and/or disinfection, and a disinfection means.

### OBJECT OF INVENTION

The object of the invention is to combine several artificial intelligence and autonomous driving technologies such as computer vision, swarm intelligence, datalink remote control, etc. together to make a brand new automated disinfection vehicle(ADV) system to help with disinfection and/or cleaning of objects or environments.

Another object is to use computer vision technology in a cleaning robot to recognize the high-risk target such as door handles, elevator buttons, counters, keyboards/mice, desks, chairs, among others that may be considered prone to dirt and microbe infection.

Yet still, it is an object of this invention to make use of computer vision technology in a cleaning robot to recognize the pedestrian and obstacles in the robot's cleaning environment.

Other comparable objectives are also contemplated herein, as well be obvious to one ordinary skill in the art.

### BACKGROUND OF THE INVENTION

With the COVID-19 pandemic, there is an immediate need for increased frequency of disinfection in public places. And also, the viral COVID-19 pandemic will forever change how we clean and disinfect long-term care facilities, hospitals, schools, airports, offices, shopping centers, and even our homes. In hospitals and health care centers around the world, environmental cleaning and disinfection of surfaces are becoming more important than ever before. Essential services like grocery stores and banks are ramping up routine sanitization efforts in desperate attempts to slow the spread and safeguard the health and safety of staff and consumers alike. Research studies show that environmental cleaning and disinfection play a pivotal role in preventing the spread of infections.

There are two primary methods of sanitization, spray-wiping, and ultraviolet (UV) light. Spray-wiping generally requires considerable human labor, wastes large amounts of chemical cleaning agents, and has incomplete coverage of the environment. UV light is harmful to humans in the immediate vicinity and generally requires a great deal of time to reach effective levels of sanitization. Current solutions are not well optimized for use in even moderate-traffic health-care environments. A few companies have made good progress automating the UV process by using a robot as a carrier, but the solutions are very expensive, bulky (as much as 2.0 cubic meters), and require all pets, patients and personnel to vacate the area.

The traditional cleaning robots made great progress these years, but up to now, they still have several problems as we listed:
1. Traditional robot collaboration methods are based on task assignments, creating issues such as task redundancy, unbalanced workloads, or other inefficiencies.
2. Traditional coverage algorithms used in applications such as vacuum robots do not have enough sensors and processing power to automatically identify and target high-risk areas, resulting in less effectively sanitized target areas.
3. Traditional robots or spraying devices are operated individually, leading to issues such as overall progress and inventory tracking. This makes it difficult to scale solutions up or down linearly according to the changing environments.
4. Traditional disinfectant devices are dedicated to singular tasks and generally difficult to re-use as requirements change.

This invention discloses an affordable Automated Disinfection Vehicle (ADV) system with innovated features: Swarm Intelligence, Smart Target Coverage Algorithm, High-speed Datalink and Smart Operation Platform, and modular design effectively address the above problems and bring down the price dramatically and drastically reduce the size (less than 0.2 cubic meters) for effective deployment in real-world situations.

### SUMMARY OF THE INVENTION

The following summary is an explanation of some of the general inventive steps for the system, method, architecture and tools in the description. This summary is not an extensive overview of the invention and does not intend to limit the scope beyond what is described and claimed as a summary.

The present invention, in some embodiments thereof, relates to an autonomous cleaning robot adapted to clean and/or disinfect an object or environment comprising of a navigation means to navigate an environment of operation to perform a cleaning and/or disinfection task, a target acquisition means making the cleaning robot is capable of detecting obstacles in its environment or objects or an environment for cleaning and/or disinfection, and a disinfection means to clean and/or disinfect detected object or an environment, the disinfection means being electrostatically operated, whereby a disinfectant in the disinfection means is charged by an electrostatic charge to increase adherence to an object or an environment to reduce the amount of disinfectant used. According to some embodiments, the navigation is autonomous, non-human operated. According to another embodiments, the robot may be coupled to a swarm intelligence via a high speed data link provided therefor.

According to an exemplary embodiment, traditional robot collaboration methods are based on task assignments, creating issues such as task redundancy, unbalanced workloads, or other inefficiencies. The current invention has applied years of experience in building agent-based swarm intelligence systems onto the automated spraying robots. As multiple robots work in the same space, they are constantly communicating with one another through the provided datalink in a decentralized manner and adjusting work assignments in real-time. This results in the minimal intersection of task areas, and our robots will quickly target high-risk areas and tackle it in the most efficient manner possible.

According to an exemplary embodiment, traditional coverage algorithms used in applications such as vacuum robots do not have the correct sensor or processing power to automatically identify and target high-risk areas, resulting in less effectively sanitized target areas. Through thousands of reinforcements learning iterations in the current invention's computer algorithm training platform, it was generated a comprehensive smart target coverage algorithm. As the robot moves around, it automatically identifies high-risk infection areas using an on-board high-resolution cameras (or any such similar means) and an AI-processing unit. At the same time, it will identify and generate a 3D profile of each high-risk object such as door handles, an elevator button, counters, etc. After generating a complete spray path in near real-time, high-intensity sanitization will be conducted automatically for these high-risk infection areas.

According to an exemplary embodiment, traditional robots or spraying devices are operated individually, leading to issues such as overall progress and inventory tracking. This makes it difficult to scale solutions up or down linearly according to the changing environments. The current invention supports multiple robots connected simultaneously through a high-speed data link, allowing a remote operator to comfortably visualize the disinfection work being conducted and quickly take over the control and respond to different emergencies as problems arise in real-time.

According to an exemplary embodiment, traditional disinfectant devices are dedicated to singular tasks and are generally difficult to re-use as requirements change. The current invention is designed with modularity and re-usability in mind for many future-proof tasks. It is provided a means to easily remove the sprayer module and replace it with a sweep and vacuum module for regular cleaning tasks or an extended battery pack module for use as a patrol robot.

### BRIEF DESCRIPTION OF THE FIGURES

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 of the drawings illustrates a block diagram for the current invention

### DETAILED DESCRIPTION OF THE INVENTION

Exemplary embodiments of this disclosure include relates to an autonomous cleaning robot adapted to clean and/or disinfect an object or environment comprising of a navigation means, a target acquisition means, and a disinfection means. These embodiments will be described with reference to the accompanying drawings. It should be noted that the embodiments described below are illustrative only, in order to describe, for example, how the autonomous cleaning robot, system and method according to this disclosure are implemented, and it is not intended to limit the invention or the like according to this disclosure to specific configurations described below. In order to implemented the invention or the like according to this disclosure, other specific configurations may be employed as appropriate according to the embodiments.

Accordingly, it should be understood that various changes and modifications may be made to the invention without departing from the spirit and scope thereof.

For purposes of this disclosure, the terms automatic cleaning robot, automatic disinfecting robot or automated disinfection vehicle (ADV) system may be used interchangeably and should be construed to have the same meaning.

Further, the terms cleaning and disinfecting may be used in this disclosure interchangeably and should also be construed to have the same meaning.

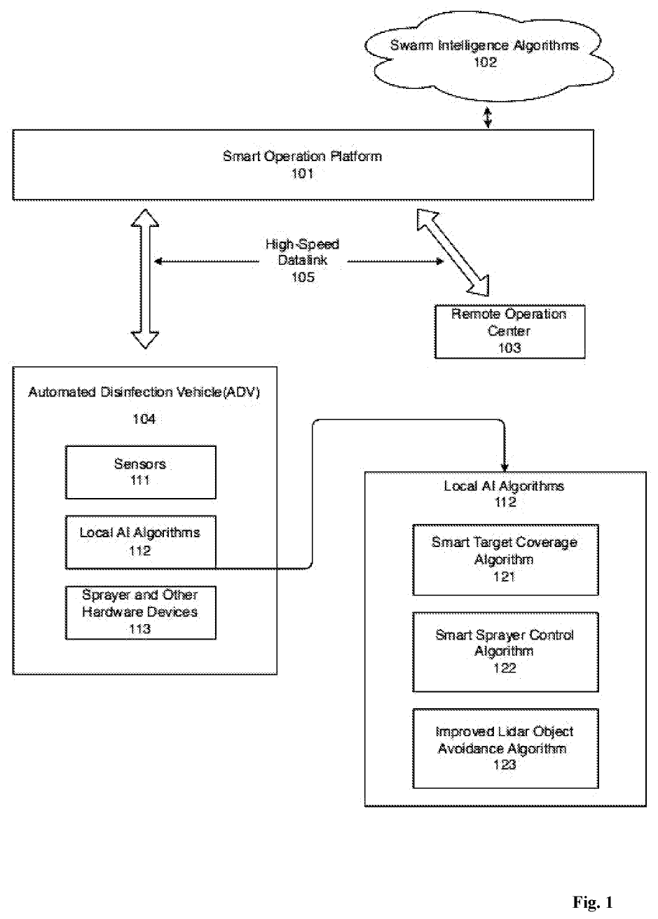

In the first embodiment according to FIG. 1 of the diagrams, is is illustrated a block diagram for the current invention comprising of one or more automatic cleaning robot or Automated Disinfection Vehicle (ADV) 104 coupled via a High-Speed Datalink 105 to a Smart Operation Platform 101. The illustrated Swami Intelligence Algorithms 102 enable the assigning of tasks to different ADVS quickly and accurately. The automatic cleaning robot according to the current invention comprises of a navigation means to navigate an environment of operation to perform a cleaning and/or disinfection task, a target acquisition means making the cleaning robot is capable of detecting obstacles in its environment or objects or an environment for cleaning and/or disinfection, and a disinfection means to clean and/or disinfect detected object or an environment.

Further, by utilizing an electrostatic disinfectant solution with the precision of a machine-learning driven robot, the current invention can greatly reduce the amount of cleaning agent used thus avoiding omissions to the environment and targeting objects or surfaces that pose a higher risk of contamination.

According to one embodiment, one remote operator operating a Smart Operation Platform 101 via the Remote Operation Center 103, is capable of visualizing and directly manage a plurality of autonomous cleaning robots and monitor their progress.

According to one embodiment, the automatic cleaning robot or Automated Disinfection Vehicle(ADV) 104 is equipped with a plurality of sensors 111, a computing facility, sprayer and Other Hardware Devices 113, and an on-board high-performance AI-processing unit that is running multiple Local A.I. Algorithms 112. The arrangement allows the use AI-driven algorithms to automate operations for precise and complete sanitization and have a remote operator step in at any time.

According to one embodiment, the High-Speed Datalink 105 and Smart Operation Platform 101 significantly improve the traditional technology. Traditional robots or spraying devices are operated individually, leading to issues such as overall progress and inventory tracking. This makes it difficult to scale solutions up or down linearly according to the changing environments. The Smart Operation Platform 101 supports a plurality of robots connected simultaneously through a High-Speed Datalink 105, allowing an operator to comfortably visualize the disinfection work being conducted and quickly take over the control and respond to different emergencies as problems arise in real-time.

According to another embodiment, traditional robot collaboration methods are based on task assignments, creating issues such as task redundancy, unbalanced workloads, or other inefficiencies. The current invention has applied years of experience in building Swarm Intelligence Algorithms 102 onto the automated spraying robots. As multiple robots work in the same space, they are constantly in communication with one another through the provided datalink in a decentralized manner and adjusting work assignments in real-time. This results in the minimal intersection of task areas, and the robots of the invention are capable of quickly target high-risk areas and tackle it in the most efficient manner possible.

Further, traditional disinfectant devices are dedicated to singular tasks and are generally difficult to re-use as requirements change. The robot 104 is designed with modularity and re-usability in mind for many future-proof tasks. There is provided a means to remove the Sprayer and Other Hardware Devices 113 and replace them with a sweep and vacuum module for regular cleaning tasks or an extended battery pack module for use as a patrol robot, or any attachments the user may see fit.

According to one embodiment, the robot 104 has a low power motor, low speed and designed with multiple safety considerations. The vehicle body is equipped with an emergency brake that can be engaged at any time during an emergency. The driver-assistance function minimizes the risk of collision. Additionally, it is also equipped with an automated driving system, but it can be controlled manually by an operator and control platform. Preferably, an operator can intervene or override for complete vehicle control and monitoring. Further, they can engage functions such as the atomization system, waterproof system, and automatic control circuit to the vehicle.

Other specifications of the autonomous robot 104 are shown below:
The non-limiting preferred dimensions include: 98 cm×72 cm×56 cm L×W×H); Weight: 60 kg.
The non-limiting preferred sensors include one or more of: H.D. Camera, LiDAR, IN1U, Proximity Sensor.
The non-limiting preferred Spray Angle includes: Horizontal 270°, Vertical 35°; Spray Distance: 2-8 m
The non-limiting preferred Operating Time: 1.5-2 hr; Solution Capacity: 30 L; Additional Technology: Electrostatic Sprayer.

It is anticipated that Sensors 111 of the cleaning robot may be easily replaced with different kinds of sensors for different purposes. The autonomous cleaning robot comprises several Local A.I. Algorithms 112 running on an on-board high-performance AI-processing unit (computing facility). They may comprise a Smart Target Coverage Algorithm 121, a Smart Sprayer Control Algorithm 122, and a Improved LiDAR Object Avoidance Algorithm 123.

According to one embodiment, the Smart Target Coverage Algorithm 121 is an improvement upon traditional coverage algorithms used in applications such as vacuum robots, which do not have the correct sensor or processing power to automatically identify and target high-risk areas, resulting in less effectively sanitized target areas. Through thousands of reinforcements learning iterations in the current invention's computer algorithm training platform, it was generated a comprehensive smart target coverage algorithm. As the robot moves around, it automatically identifies high-risk infection areas using an on-board high-resolution cameras (or any such similar means) and an AI-processing unit. At the same time, it will identify and generate a 3D profile of each high-risk object such as door handles, an elevator button, counters, etc. After generating a complete spray path in near real-time, high-intensity sanitization will be conducted automatically for these high-risk infection areas.

A major technical challenge to overcome in the implementation of the Smart Sprayer Control Algorithm 122 is ensuring that the robot is capable of completely sanitizing the areas that it is attempting to disinfect. This challenge is difficult due to the high standard that is needed to declare an area as disinfected. When one spot is missed by the sanitizer, it is counted as a failure. The main contributor of this issue is the fact that different surfaces and sports require different amounts of sanitizer to ensure that they have been disinfected.

A balance is needed such that the a sprayer performs its task with just enough sanitizer that ensures disinfection while also not using too much sanitizer. If the robot uses too much sanitizer on certain areas, it would reduce the life span of the robot's sanitizer tank while also making the areas that have been sanitized unpleasant for humans to touch (e.g., Slippery door handles). According to one preferred embodiment, the invention overcomes said technical challenge by creating a simulation in a simulation computer program. In the simulation environment, a theoretical optimal pressure and the spray angle is determined for different objects. After adjusting the physical spraying module, the sanitizing module can spray sanitizer in a more even fashion while also training the automated system to identify how much sanitizer will be needed to successfully sanitize the infected area. As such, the Smart Sprayer Control Algorithm 122 has a means to analyze the shape and size of different objects and find the optimal pressure and the spray angle to optimize the disinfection process.

According to one preferred embodiment, the LiDAR Object Avoidance Algorithm 123 comprises an object avoidance system needs to be improved to anticipate fast-moving objects. According to the embodiment, the system is able to react to slow-moving objects and people with ease, but the fast-moving objects may cause some problems to the robot. However, these may he overcome pursuant to a few considerations that need to be taken into account when optimizing this system. For example, if an object is moving fast towards the robot, there should be a better object avoidance algorithm than just simply freeze the operation. If it were to move out of the way quickly, the vehicle could unintentionally move into the path of the person running. However, and on the same note, in the case of a large moving object or group of people, there is a good chance that someone does not see the robot, and may crash into the robot. In this case, the best course of action is to move and avoid the objects. As such, the invention makes a decision on a situation basis to determine if the robot should stop moving and stay still to avoid the object/person, or should it move out of the way. The system will only know what to do if exposed to these different scenarios.

The Swarm Intelligence Algorithms 102 embody a computer-implemented means to coordinate activities between a plurality of autonomous cleaning robots 104. More specifically, it comprises a means for receiving from said said plurality of autonomous cleaning robots inputs comprising at least in part of navigation inputs, disinfection inputs and target acquisition inputs. The module 102 is capable of performing an analysis on the received inputs using a suitably trained machine learning algorithm to determine actionable optimized instruction for at least one of connected autonomous cleaning robots. Such an actionable optimized instruction may comprise a navigation plan, a disinfection task and/or a target acquisition plan. The module 102 is further capable of transmitting to at least one of connected autonomous cleaning robots the actionable optimized instruction, causing it to perform the transmitted navigation plan, disinfection task and/or its target acquisition based on received actionable optimized instruction.

Further according to another embodiment, it is provided a method of training a computer algorithm for an autonomous cleaning robot adapted to clean and/or disinfect an object or environment, the method comprising of providing a plurality of images of objects and/or environments that need to be disinfected, providing a disinfection pattern for each of the identifiable objects and/or environments in, whereby the pattern may comprise at least in part of a frequency and/or path for the cleaning and/or disinfection, using an untrained algorithm, predicting for at least some of the provided plurality of images of objects and/or environments a disinfection pattern model, subsequently validating the predicted disinfection pattern model with the provided disinfection pattern until the desired model accuracy is achieved, and finally outputting a prediction model capable of accurately predicting a disinfection pattern.

It is to be understood that the provided plurality of images of objects and/or environments are from either or both of a plurality of autonomous cleaning robots.

It is further to be understood that the provided disinfection patterns for each of the identifiable objects and/or environments are derived from either or both of a plurality of autonomous cleaning robots or a means provided to coordinate activities between a plurality of autonomous cleaning robots.

It is further to be understood that additionally, the algorithm will attempt to predict a navigation path and a disinfecting and/or cleaning path.

Further still, and according to another embodiment, it is provided a method of applying the trained computer algorithm to an autonomous cleaning robot adapted to clean and/or disinfect an object or environment, the method comprising of receiving a plurality of images of objects and/or environments from a robot applying said algorithm, using a trained algorithm for predicting a disinfection pattern model for the provided plurality of images of objects and/or environments, and finally outputting a disinfection pattern, and causing the autonomous cleaning robot to autonomously perform a disinfection task based on the predicted disinfection pattern.

It is to be understood that the algorithm may further be capable of analyzing the shape and/or size of an object or an environment to disinfect to optimize the cleaning and/or disinfection task.

It is to be further understood that the use of a trained algorithm may also include the generation of a model of an object or an environment to disinfect to optimize the cleaning and/or disinfection task.

It is also to be understood that the use of a trained algorithm may also include the generation of a disinfection path for application by the autonomous robot.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICATION

The invention is applicable in the robotics industry, health industry and any such industry that makes use or manufactures sanitary machines.

1. An autonomous cleaning robot adapted to clean and/or disinfect an object or environment, the robot comprising of:
a navigation means to navigate an environment of its operation to perform a cleaning and/or disinfection task, said navigation means being characterized at least in part of an autonomous, non-human operated navigation ability;
a target acquisition means, wherein said cleaning robot is capable of detecting at least in part of obstacles in its environment or an object or an environment for cleaning and/or disinfection; and
a disinfection means to clean and/or disinfect an object or an environment, the disinfection means being electrostatically operated, wherein, a disinfectant in the disinfection means is charged by an electrostatic charge to increase adherence to an object or an environment to reduce the amount of disinfectant used.

2. The autonomous cleaning robot as in claim 1, wherein the target acquisition means is capable of analyzing the shape and/or size of an object or an environment to disinfect to optimize the cleaning and/or disinfection task.

3. The autonomous cleaning robot as in claim 2, wherein the target acquisition means is further capable of generating a model for an object or an environment to disinfect to optimize the cleaning and/or disinfection task.

4. The autonomous cleaning robot as in claim 1, wherein the robot further comprises of a means to generate a path for disinfection based the output of said target acquisition means.

5. The autonomous cleaning robot as in claim 1, wherein the robot further comprises of a means to generate a path for disinfection based the output of said target acquisition means.

6. The autonomous cleaning robot as in claim 1, wherein a means to coordinate activities between said autonomous cleaning robot and a plurality of autonomous cleaning robots is provided therefor.

7. The autonomous cleaning robot as in claim 6, wherein said plurality of autonomous cleaning robots are within the same environment and location.

8. The autonomous cleaning robot as in claim 6, wherein said plurality of autonomous cleaning robots are within different environment and location.

9. The autonomous cleaning robot as in claim 1, wherein the target acquisition means comprises of a camera.

10. The autonomous cleaning robot as in claim 1, further comprising an on-board computer adapted to operate said navigation means, target acquisition means and disinfection means.

11. The autonomous cleaning robot as in claim 6, wherein said means to coordinate activities between said plurality of autonomous cleaning robots is characterized by:
a means for receiving from said said plurality of autonomous cleaning robots inputs comprising at least in part of:
navigation inputs;
disinfection inputs; and
target acquisition inputs;
a means for performing an analysis on said received inputs using a suitably trained machine learning algorithm to determine actionable optimized instruction for at least one of said plurality of autonomous cleaning robots, the actionable optimized instruction comprising at least in part of:
navigation plan;
disinfection task; and
target acquisition; and
a means for transmitting to at least one of said plurality of autonomous cleaning robots said actionable optimized instruction, wherein said at least one of the plurality of autonomous cleaning robots is capable of altering at least one of its navigation plan, disinfection task and/or its target acquisition based on received actionable optimized instruction.

12. A method of training a computer algorithm for an autonomous cleaning robot adapted to clean and/or disinfect an object or environment, the method comprising of:
providing a plurality of images of objects and/or environments;
providing a disinfection pattern for each of the identifiable objects and/or environments in provided plurality of images, wherein said pattern may comprise at least in part of a frequency and/or path for the cleaning and/or disinfection;
predicting for at least some of the provided plurality of images of objects and/or environments a disinfection pattern model;
validating the predicted disinfection pattern model with the provided disinfection pattern until the desired model accuracy is achieved; and
outputting a prediction model capable of accurately predicting a disinfection pattern.

13. The method of claim 12, wherein provided plurality of images of objects and/or environments are from either or both of a plurality of autonomous cleaning robots.

14. The method of claim 12, wherein the provided disinfection patterns for each of the identifiable objects and/or environments are derived from either or both of a plurality of autonomous cleaning robots or a means provided to coordinate activities between a plurality of autonomous cleaning robots.

15. The method of claim 12, further comprising providing a plurality of navigation inputs for navigating a plurality of environments, wherein said algorithm will attempt to predict a navigation path and a disinfecting and/or cleaning path.

16. The method of claim 12, wherein said algorithm comprises any such suitable machine learning algorithm such as but not limited to a neural network or any such.

17. A method of applying a trained computer algorithm to an autonomous cleaning robot adapted to clean and/or disinfect an object or environment, the method comprising of:
receiving a plurality of images of objects and/or environments;
predicting a disinfection pattern model for at least some of the provided plurality of images of objects and/or environments;
outputting a disinfection pattern, and causing the autonomous cleaning robot to autonomously perform a disinfection task based on the predicted disinfection pattern.

18. The method of claim 17, further comprising analyzing the shape and/or size of an object or an environment to disinfect to optimize the cleaning and/or disinfection task.

19. The method of claim 17, further comprising generating a model for an object or an environment to disinfect to optimize the cleaning and/or disinfection task.

20. The method of claim 17, further comprising generating a disinfection path.
